(19) United States
(12) Patent Application Publication
(10) Pub. No.: US 2025/0065638 A1
(43) Pub. Date: Feb. 27, 2025

(54) CARTRIDGE AND LIQUID EJECTION APPARATUS

(71) Applicant: CANON KABUSHIKI KAISHA, Tokyo (JP)

(72) Inventors: TATSUO NANJO, Kanagawa (JP); KEISUKE IINUMA, Kanagawa (JP); WATARU TAKAHASHI, Kanagawa (JP); KEIICHIRO TSUKUDA, Kanagawa (JP); TAKASHI HAYASAKA, Kanagawa (JP)

(21) Appl. No.: 18/794,960

(22) Filed: Aug. 5, 2024

(30) Foreign Application Priority Data
Aug. 21, 2023 (JP) 2023-133942

(51) Int. Cl. B41J 2/175

(52) U.S. Cl. CPC B41J 2/17553; B41J 2/1753

(57) ABSTRACT

Disclosed is a cartridge that includes a case including a storage portion for storing liquid and a flow path that communicates with the storage portion; an element substrate including an ejection port that communicates with the storage portion via the flow path and that ejects liquid contained in the storage portion; and an electric wiring substrate that is electrically connected to the element substrate. The case has a surface to which the element substrate and the electric wiring substrate are fixed. Viewed from a direction perpendicular to the surface, a slit is provided in at least one long side of an outer periphery of the surface.

### BACKGROUND

### Field

The present disclosure relates to a cartridge and a liquid ejection apparatus.

### Description of the Related Art

Some liquid ejection apparatuses, such as inkjet printers, use a cartridge in which a liquid storage chamber and a liquid ejection portion are integrated and that is attachable to and removable from the apparatus.

To date, there is known a so-called serial liquid ejection apparatus that ejects liquid in a desired pattern onto a medium by scanning a cartridge in a direction perpendicular to the transport direction of the medium while transporting the medium, onto which the liquid is ejected, by a certain amount at a time. In particular, a configuration described in Japanese Patent No. 4708887 discusses the configuration of the cartridge. An ink absorber that holds ink is disposed inside of a body member, and a recording element substrate is attached to a lower part thereof in the gravitational direction. The ink held in the ink absorber is guided to the element substrate through a filter and an ink flow path, and an image or the like is formed on a medium as the ink is ejected from the element substrate.

### SUMMARY

It is desirable to reduce the size of the liquid ejection apparatus including the cartridge described above in view of space saving.

Thus, an aspect of the present disclosure provides a cartridge including a case including a storage portion for storing liquid and a flow path that communicates with the storage portion; an element substrate including an ejection port that communicates with the storage portion via the flow path and that is configured to eject liquid contained in the storage portion; and an electric wiring substrate that is electrically connected to the element substrate. The case has a surface to which the element substrate and the electric wiring substrate are fixed. Viewed from a direction perpendicular to the surface, a slit is provided in at least one long side of an outer periphery of the surface.

Another aspect of the present disclosure provides a liquid ejection apparatus that includes a cartridge with a case that includes a storage portion for storing liquid and a flow path that communicates with the storage portion; an element substrate including an ejection port that communicates with the storage portion via the flow path and that is configured to eject liquid contained in the storage portion; and an electric wiring substrate that is electrically connected to the element substrate. The case has a surface to which the element substrate and the electric wiring substrate are fixed. Viewed from a direction perpendicular to the surface, a slit is provided in at least one long side of an outer periphery of the surface. Further features of the present disclosure will become apparent from the following description of exemplary embodiments with reference to the attached drawings.

### BRIEF DESCRIPTION OF THE DRAWINGS

FIG. 1 is a schematic view of a liquid ejection apparatus according to a first embodiment.

FIG. 2A is a perspective view of a cartridge according to the first embodiment, and FIG. 2B is an exploded perspective view of the cartridge according to the first embodiment.

FIG. 3 is another perspective view of the cartridge according to the first embodiment.

FIG. 4 is a sectional view of the cartridge according to the first embodiment.

FIGS. 5A and 5B are schematic views of the liquid ejection apparatus.

FIG. 6 is a bottom view of the cartridge according to the first embodiment viewed from the element substrate side.

FIG. 7 is a bottom view of the cartridge according to the first embodiment viewed from the element substrate side, from which an electric wiring substrate is omitted.

FIG. 8 is a perspective view illustrating a state in which the cartridge has dropped and collided with a floor surface.

FIG. 9 is another perspective view illustrating a state in which the cartridge has dropped and collided with a floor surface.

FIG. 10 is another view illustrating a state in which the cartridge has dropped and collided with a floor surface.

FIG. 11 is a perspective view illustrating individual packaging of the cartridge.

FIG. 12 is a view illustrating elements included in the individual packaging.

FIG. 13 is a view illustrating an individual packaging box and a blister pack.

FIG. 14 is a view illustrating how the blister pack is contained in the individual packaging box.

FIG. 15 is an exploded perspective view of a cartridge according to a second embodiment.

FIG. 16 is a bottom view of the cartridge according to second embodiment viewed from the element substrate side.

FIG. 17 is a perspective view of a cartridge according to another embodiment.

### DESCRIPTION OF THE EMBODIMENTS

Hereafter, embodiments of the present disclosure will be described in detail with reference to the drawings.

### First Embodiment

### <Liquid Ejection Apparatus>

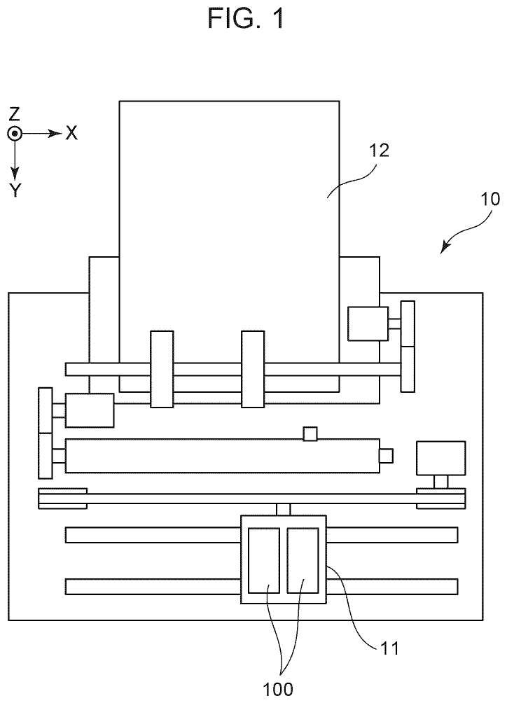

FIG. 1 is a schematic view illustrating an inkjet printer as a liquid ejection apparatus 10 according to the present embodiment (hereafter, also referred to as an apparatus 10). In FIG. 1, the X direction is the scanning direction of a carriage (also referred to as the body-width direction), the Y direction the transport direction of a medium, and the Z direction is the vertical or upward direction.

Also in the following figures for describing the cartridge alone, the XYZ axes that are the same as those of this figure are shown based on a case where the cartridge is mounted on the apparatus 10. The liquid ejection apparatus 10 is configured so that a cartridge 100 can be mounted on a carriage 11. The liquid ejection apparatus 10 is an on-carriage-type serial liquid ejection apparatus that ejects liquid (also referred to as ink) while the cartridge 100 mounted on the carriage 11 moves relative to a medium 12. In ejection, the cartridge 100 ejects liquid while the carriage 11 reciprocates in the X direction. An image is formed on the medium 12 by transporting, in synchronism with ejection of liquid from the cartridge 100, the medium 12 in a direction (the Y direction) perpendicular to the direction in which the carriage 11 reciprocates.

### <Cartridge Configuration>

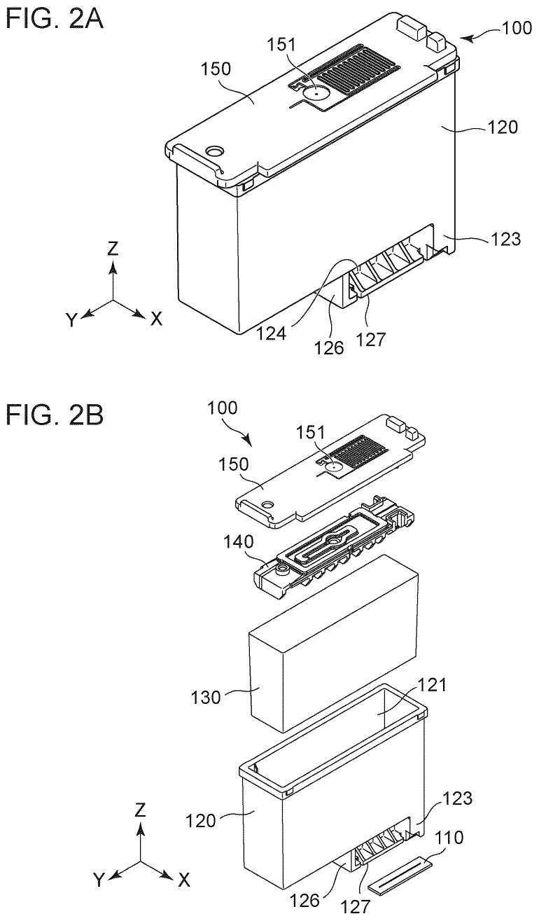

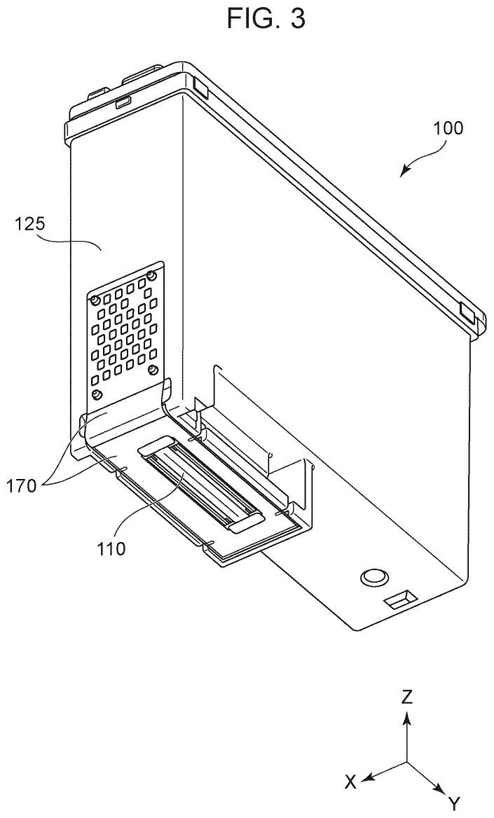

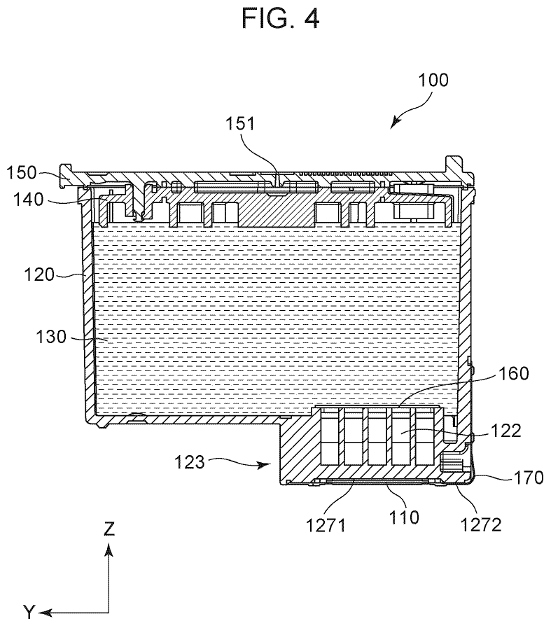

FIG. 2A is an external perspective view of the cartridge 100 viewed from the +Z direction, and FIG. 2B is an exploded perspective view of the cartridge 100 viewed from the +Z direction. FIG. 3 is an external perspective view of the cartridge 100 viewed from the −Z direction. FIG. 4 is a sectional view of the cartridge 100 along the Y-Z plane. The cartridge 100 illustrated in FIGS. 2A to 4 contains ink of a single color therein, for example, is a cartridge containing only black ink. The cartridge 100 includes an element substrate 110 for ejecting liquid, a case 120 in which a storage chamber (storage portion) 121 for storing liquid is formed, a rib plate 140, and a cover 150. In the storage chamber 121, a filter 160 (FIG. 4) and an absorber 130 that holds the contained liquid are accommodated. The liquid held by the absorber 130 is supplied to an ejection port of the element substrate 110 via a flow path portion (122, FIG. 4) communicating with the storage chamber 121. In the present embodiment, the absorber 130 is inserted into the storage chamber 121 as a negative pressure generator for holding liquid. However, a configuration using a negative pressure generator, such as a pressure controller or a circulator, can hold liquid in the same way.

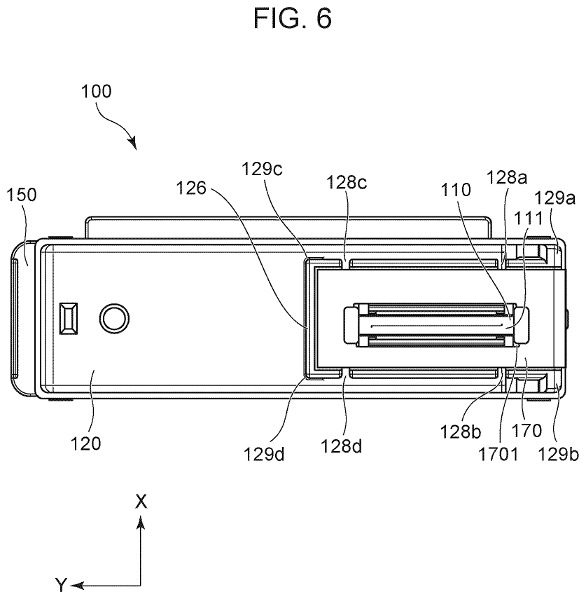

The element substrate 110 is an ejection portion that ejects ink and includes an element (such as a heater or a piezoelectric element) that provides liquid with energy to eject the liquid. The element substrate 110 has an ejection port row 111 (FIG. 6) in which ejection ports are arranged. The element substrate 110 is disposed on a support surface 127 that is the bottom surface of the case 120 on the lower side in the gravitational direction. That is, the element substrate 110 is disposed on the bottom surface of the entirety of the cartridge 100, and, when ejecting liquid, ejects the liquid in a state in which the element substrate 110 is close to the medium 12. The support surface 127 will be described below.

The absorber according to the present embodiment is constituted by, for example, a fibrous body or a porous body, and can hold ink therein by capillary action. The absorber 130 is contained in the storage chamber 121 of the case 120 to be in contact with the filter 160, which can trap foreign substances such as dust in ink. Ink in the absorber 130 is supplied to the element substrate 110 via the filter 160 and a flow path 122.

The absorber 130 desirably has a substantially cubic shape in view of liquid supplying performance. However, in a case where the width of the cartridge is to be reduced or the size of the absorber 130 is to be changed in consideration of liquid storing capacity as in the present embodiment, the absorber 130 may be extended in the gravitational direction (the Z direction). If the size of the absorber 130 is increased in the scanning direction (the X direction), the width of the cartridge 100 widens, and the size of the entirety of the apparatus increases. If the size of the absorber 130 is increased in the direction (the Y direction) in which the ejection ports are arranged, the length of the flow path from the absorber 130 to the element substrate 110 increases, and flow resistance when supplying liquid might increase.

The cover 150 is disposed so as to close the opening of the case 120 at a top of the storage chamber 121. An air communication port 151 is provided in the cover 150, and it is possible to take air to the inside by the amount of liquid in the absorber 130 consumed by ejection. The rib plate 140 is disposed between the absorber 130 and the cover 150, and immovably holds the absorber 130.

The cartridge 100 further includes an electric wiring substrate 170 that includes a wiring portion electrically connected to the element substrate 110 and that supplies a drive signal and the like to the element (FIG. 3).

### <Cartridge and Apparatus>

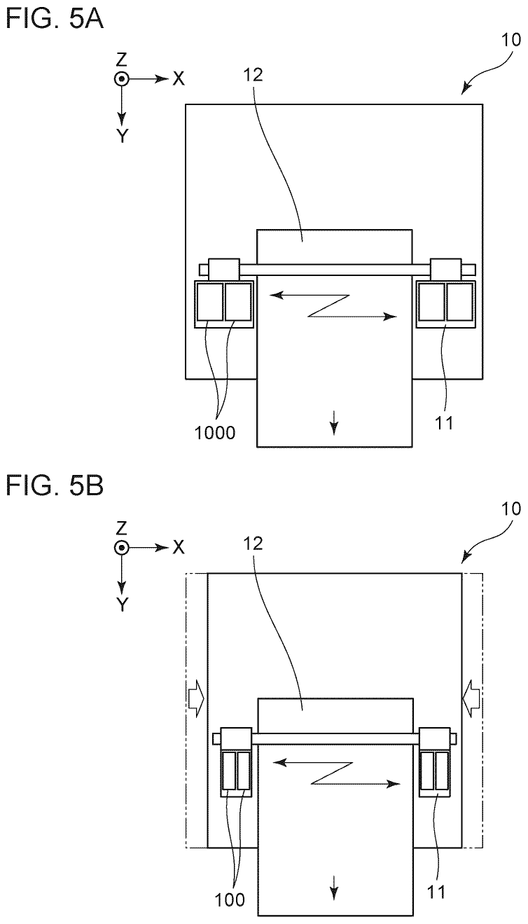

The relationship between a cartridge and the size of a liquid ejection apparatus will be described. FIGS. 5A and 5B are each a schematic view illustrating the respective sizes of the cartridge and the liquid ejection apparatus in the body-width direction. In each of FIGS. 5A and 5B, a state in which a carriage on which a cartridge is mounted is located at one end of the scanning range and a state in which the carriage is located at the other end of the scanning range are simultaneously illustrated in one figure. FIG. 5A is a schematic view for describing a cartridge and an apparatus 10 according to a related art, and FIG. 5B is a schematic view for describing the cartridge and the apparatus 10 according to the present embodiment. The width in the carriage scanning direction of the cartridge 100 according to the present embodiment illustrated in FIG. 5B is small, compared with that of a head-integrated cartridge 1000 of FIG. 5A.

The scanning range of the carriage is determined so that the scanning range exceeds the width of the medium 12 and so that the carriage and the medium 12 do not overlap when the carriage is positioned at both ends of the scanning range, and the body-width is also determined in accordance with this. Thus, the width of the liquid ejection apparatus body is approximately determined by the width of the medium 12, such as a paper sheet, and the width of the cartridge. Therefore, it is possible to reduce the body width by reducing the width of the cartridge (FIG. 5B). Reduction of the scanning distance of the carriage leads to reduction of the scanning time per reciprocation of the carriage and provides an advantageous effect in that throughput is improved.

The cartridge may have a large size in the scanning direction when mounted on the carriage, and has, for example, a size of 29.5 mm in the X direction and a size (height) of 42.0 mm in the Z direction. In contrast, the cartridge 100 according to the present embodiment has, for example, a size of 22 mm in the X direction and a size of 56.5 mm (excluding a projecting portion) in the Z direction. That is, compared with the cartridge according to the related art, the cartridge 100 has a size in the X direction (horizontal width dimension) that is smaller by 7.5 mm and oppositely has a size in the Z direction (height dimension) that is larger by 14.5 mm. The ratio of the size of the cartridge in the X direction and the size of the cartridge in the Z direction is 1.4 in the related-art example and 2.6 in the present embodiment. As described below, the present disclosure is more suitably applicable to a thin cartridge whose ratio of the size in the Z direction to the size in the X direction is large as in the present embodiment. To be specific, the ratio of the size in the Z direction to the size in the X direction is greater than or equal to 2.0 and less than or equal to 3.0, and may be greater than or equal to 2.4 and less than or equal to 2.8, in view of the balance between the rigidity of the cartridge and the liquid storing capacity. In other words, when a first direction is a direction in which a plurality of ejection ports are arranged, a second direction is a direction that is parallel to the support surface 127 and perpendicular to the first direction, and a third direction is a direction that is perpendicular to both of the first direction and the second direction, the ratio of the length of the cartridge in the third direction to the length of the cartridge the second direction may be greater than or equal to 2.0 and less than or equal to 3.0, and may be greater than or equal to, 2.4 and less than or equal to 2.8. When the length of the case 120 in the second direction is less than or equal to 25 mm, the cartridge 100 is configured to be capable of obtaining greater advantageous effects of the present disclosure.

### <Mount Portion>

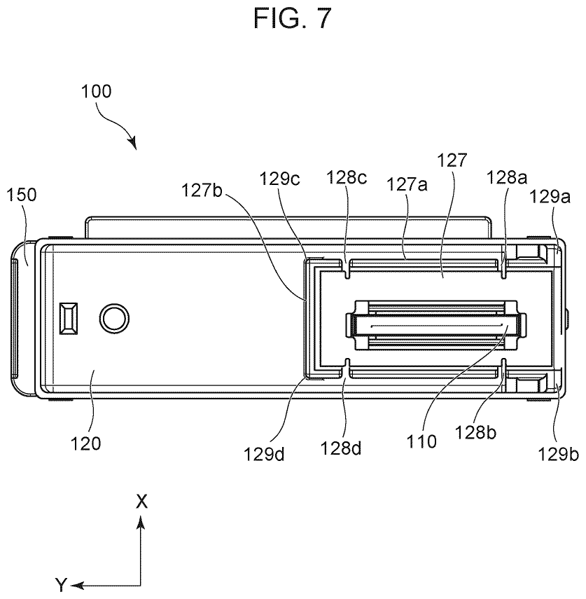

Next, a mount portion 123 and the support surface 127 will be described. FIG. 6 is a bottom view of the cartridge 100 viewed from the element substrate 110 side, and FIG. 7 is a view in which the electric wiring substrate 170 is omitted from FIG. 6. The mount portion 123 is a portion partially protruding from the case 120 having a substantially rectangular-parallelepiped shape, and, as illustrated in FIG. 4, the flow path 122 is provided inside of the mount portion 123.

A flow path wall 124 (FIG. 2A), a front surface 125, and a mount portion rear surface 126 form the mount portion 123. The element substrate 110 and the electric wiring substrate 170 are each fixed to the support surface 127 by using an adhesive. As illustrated in FIG. 4, in the present embodiment, the support surface 127 includes a first surface 1271 that supports the element substrate 110 and a second surface 1272 that supports the electric wiring substrate 170. The electric wiring substrate 170 serves to electrically connect the element substrate 110 and the liquid ejection apparatus 10, and is electrically connected to the element substrate 110. The cartridge according to the present embodiment illustrated in FIGS. 6 and 7 has a configuration such that the electric wiring substrate 170, which is a flexible wiring substrate, has an opening that exposes the element substrate 110 and that has an electric connection portion with the element substrate 110. However, this configuration is not a limitation, and the present disclosure is also applicable to, for example, a cartridge having a configuration such that one edge of the electric wiring substrate is close to and electrically connected to one edge of the element substrate.

In the present embodiment, for example, when seen in a plan view in a direction perpendicular to the support surface 127, the percentage of the area that the element substrate 110 occupies in the support surface 127 is about 10%, and the percentage of the area that the electric wiring substrate 170 occupies in the support surface 127 is about 53%. That is, the element substrate 110 and the electric wiring substrate 170 occupy 60% or more of the region of the support surface 127.

In the present embodiment, the support surface 127 has, for example, a size (width) of about 16 mm in the X direction, a size (depth) of about 35 mm in the Y direction, and a size (thickness) of about 2 mm in the Z direction. The element substrate 110 has a size of about 2.5 mm in the X direction, a size of about 23 mm in the Y direction, and a size of about 1 mm in the Z direction. The support surface 127 and the element substrate 110 each have an elongated substantially rectangular shape such that the size in the Y direction is twice or more of the size in the X direction. When the aspect ratio of the planar shape of the support surface 127 and the element substrate 110 is large in this way, deformation due to a dropping impact may easily occur as described below in detail. When a first direction is a direction in which a plurality of ejection ports are arranged and a second direction is a direction that is parallel to the support surface 127 and perpendicular to the first direction, if the ratio of the length of the element substrate 110 in the first direction to the length of the element substrate 110 in the second direction is greater than or equal to 5, advantageous effects of the present disclosure can be more easily obtained. Moreover, also if the length of the element substrate 110 in the first direction is greater than or equal to 15 mm, advantageous effects of the present disclosure can be more easily obtained.

<Deformation from Cartridge Impact>

Reduction in size in the body-width direction (cartridge scanning direction) is required. FIGS. 5A and 5B provide schematic views illustrating the relationship between the size of a cartridge and the size of a liquid ejection apparatus in the body-width direction. In FIGS. 5A and 5B, a state in which a carriage on which a cartridge is mounted is located at one end of the scanning range and a state in which the carriage is located at the other end of the scanning range are simultaneously illustrated in one figure. The scanning range of the carriage and the body width are determined so that the scanning range exceeds the width of a medium 12 and so that the carriage and the medium 12 do not overlap when the carriage is positioned at both ends of the scanning range. Thus, the width of the liquid ejection apparatus body (hereafter, also referred to as apparatus body or body) is approximately determined by the width of the medium 12, such as a paper sheet, and the width of the cartridge. Therefore, it is possible to reduce the body-width of the liquid ejection apparatus by reducing the width of the cartridge (FIG. 5B). Reduction of the scanning region of the carriage leads to reduction of the scanning time of the carriage, and also provides another advantage in that throughput is improved.

When the width of the cartridge is reduced, the rigidity of the cartridge itself decreases, and breakage of the carriage may easily occur due to a strong impact such as dropping. In particular, breakage of the recording element substrate may occur. When the cartridge drops and the vicinity of the element substrate collides with a floor surface or the like, a mount portion to which the element substrate is fixed deforms so as to bend instantaneously. In a case where the cartridge width is narrow, since the flexural rigidity is low compared with a case where the width is wide, deformation amount when the cartridge is dropped is large. As a result, deformation of the mount portion may cause breakage of the element substrate and may lead to ejection failure.

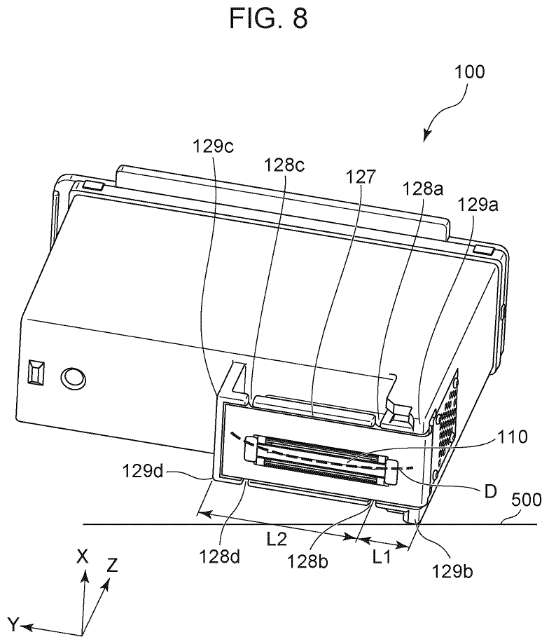

An impact that the cartridge receives may deform the cartridge, for example when the cartridge is dropped onto a floor surface or the like. FIG. 8 is a perspective view illustrating a state in which the cartridge 100 has collided with a floor surface 500, illustrating a state in which the cartridge 100 has collided with the floor surface 500 from a support surface corner 129b at an angle such that the largest-area surface (Y-Z surface) of the case 120 is inclined by 0 to 45° with respect to the floor surface 500. Dropping hen the cartridge may cause a corner of the support surface 127 to first collide with the floor surface 500, which may cause breakage of the element substrate 110.

When the cartridge collides with the floor surface, the impact may be instantaneously applied to the support surface 127 in such a way that the entire support surface 127 deforms, resulting in bending in the direction of a dotted line D (FIG. 8). Since the support surface 127 has an elongated substantially rectangular shape as described above, a long side 127a (FIG. 7) that forms an outer periphery of the support surface 127 deforms in such a way as to bend. In a case of a thin cartridge as in the present embodiment, compared with a cartridge according to the related art, the ratio of the width (length in the X direction) of the support surface 127, that is, the length of a short side 127b, to the length of the support surface 127 in the depth direction (the Y direction), that is, the length of the long side 127a, is small. Therefore, the rigidity of the cartridge in the direction of the dotted line D is low compared with that of a cartridge according to the related art, and the bending deformation amount tends to be large. If the support surface 127 bends by a large amount, the element substrate 110, which is fixed to the support surface 127, also receives a stress, and may deform by a large amount as with the support surface 127. The element substrate 110 has a comparatively small thickness, and, in particular, if the aspect ratio of the planar shape of the element substrate 110 is large as in the present embodiment, the element substrate 110 may break due to bending of the support surface 127 when dropped.

### <Plurality of Slits>

In order to suppress the bending of the support surface 127 and the element substrate 110 due to an impact on the cartridge when the cartridge drops or the like, a plurality of slits are formed in sides that form the outer periphery of the support surface 127 viewed from a direction perpendicular to the support surface 127. In the present embodiment illustrated in FIGS. 6 and 7, the plurality of slits 128 (128a, 128b, 128c, and 128d) are formed in the long sides 127a of the support surface 127. In the present embodiment, on the flow path 122 side, which is the +Z side, of the support surface 127, a space is formed between the support surface 127 and the storage chamber 121 (FIGS. 2A, 2B, and 3). Therefore, the plurality of slits are formed so as to extend through the support surface 127 in the Z direction. In FIGS. 6 and 7, the slits 128a and 128b are disposed at positions that face each other in the X direction with the support surface 127 therebetween, and, likewise, the slits 128c and 128d are disposed at positions that face each other in the X direction with the support surface 127 therebetween.

Viewed from a direction perpendicular to the support surface 127, the distance from the front surface 125 to the slits 128a and 128b in a direction along the long side 127a is about 8 mm, and the distance from the mount portion rear surface 126 to the slits 128c and 128d in a direction along the long side 127a is about 6 mm. That is, each of the slits 128 is provided in the vicinity of a corresponding one of the four corners 129a, 129b, 129c, 129d of the support surface 127 in the mount portion 123. As described below, when the cartridge drops and any of the corners of the support surface 127 collides with a floor surface or the like, the slit 128 functions as a bending point of a side that forms an outer periphery of the support surface 127, and thereby suppresses deformation of the support surface 127. Therefore, in order that the slit 128 can function as a bending point before the support surface 127, to which the element substrate 110 is fixed, deforms, the slit 128 is provided in the vicinity of each of the four corners of the support surface 127, and may be provided at a position separated from the center of the long side 127a.

Upon cartridge drop and collision, the width of the slit 128 deforms in a direction such that the width opens or closes in a direction parallel to the side 127a having the slit 128. In order that the slit 128 can sufficiently function as a bending point of a side of the support surface 127, the length of the slit 128 may be greater than or equal to 2.0 mm and may be greater than or equal to 2.5 mm. The length of the slit 128 according to the present embodiment is 2.5 mm. When the slit width has a sufficient length, viewed from a direction perpendicular to the support surface 127, at least a part of the slit 128 may overlap the electric wiring substrate 170 as illustrated in FIGS. 6 and 7. As described above, the cartridge according to the present embodiment illustrated in FIGS. 6 and 7 has a configuration such that the electric wiring substrate 170, which is a flexible wiring substrate, has an opening 1701 that exposes the element substrate 110 and that has an electric connection portion with the element substrate 110. Therefore, the slit 128 formed in the long side 127a is provided in the second surface 1272 of the support surface 127. Moreover, in a configuration such that the element substrate 110 is disposed in the opening 1701 of the electric wiring substrate 170, the electric wiring substrate 170 may contact a suction of the apparatus 10 that is configured for cleaning for allowing stable ejection by suctioning ink from the element substrate 110. Therefore, since the lower surface of the electric wiring substrate 170 on the support surface 127 may be a flat surface, and thus the slit width may be narrower. For this reason, in the present embodiment, viewed from a direction perpendicular to the support surface 127, the width of the slit 128 is changed in such a way that the width of a portion located below the electric wiring substrate 170 is about 0.5 mm and the width of a portion that does not overlap the electric wiring substrate 170 is about 2.5 mm. Thus, the electric wiring substrate 170 on the support surface 127 is sufficiently smooth so as not to affect contact with the suction. Such a shape of the slit 128, in that the width decreases from the outer peripheral side toward the center of the support surface 127, is desirable in view of improvement of the durability of a die that is used in the process of manufacturing the case 120 including the slit 128. The case 120 according to the present embodiment is formed from a thermoplastic resin by using a die. To form the slit shape, the die needs to have the same shape as the slit. However, for example, a die shape having a width of about 0.5 mm and a length about 2.5 mm has low strength and may lack durability. Therefore, the slit has a two-step-width shape such that the width is about 0.5 mm and the length is a minimum length of about 1 mm below the electric wiring substrate 170 and the width is about 1.5 mm and a length is about 1.5 mm in the other regions to be thicker and to have a higher strength. Thus, the slit 128 according to the present embodiment has both of the function of suppressing deformation of the support surface and the function of improving the durability of a die when forming the case 120. However, the shape of the slit 128 according to the present disclosure is not limited to the two-step-width shape. For example, a width shape having three or more steps or a tapering shape may be used.

<Function of Slit when Cartridge Drops>

Next, the function of the slit 128 when the cartridge drops will be described. As described above, when the cartridge drops and collides with a floor surface or the like, if the support surface 127 deforms in such a way as to bend, the element substrate 110 may break.

Therefore, the cartridge 100 according to the present disclosure has the slits 128 provided in the support surface 127. As illustrated in FIG. 8, when the dropped cartridge collides with the floor surface 500 at the corner 129b, a stress acts on the support surface 127 so as to generate bending deformation. At this time, among the slits 128a and 128b located in the vicinity of the collided part, the slit 128a deforms so that the width narrows and the slit 128b deforms so that the width widens. That is, the support surface 127 deforms with the slits 128a and 128b as bending points. At this time, when L1 is a region of the long side 127a from the corner 129b to the slit 128b and L2 is a region of the long side 127a from the slit 128b to the corner 129d, although L1 and L2 deform relative to each other due to the bending points of the slits 128a and 128b, deformation in the regions L1 and L2 is suppressed to be small. That is, since the long side 127a and the entirety of the support surface 127 deform in a V-shape with the slits 128a and 128b as the bending points, bending deformation in the regions L1 and L2 is suppressed. Since most of the element substrate 110 is disposed in the region L2, the element substrate 110 does not deform severely, and, as a result, it is possible to suppress breakage of the element substrate 110 even if dropping as illustrated in FIG. 8 occurs.

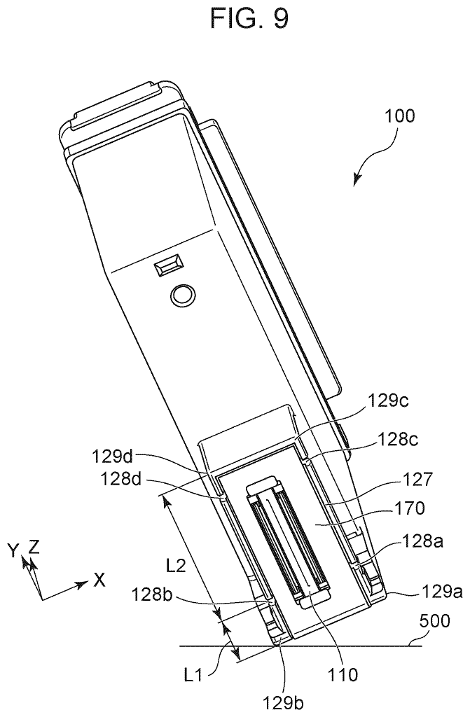

FIG. 9 is another perspective view illustrating a state in which the cartridge 100 has collided with the floor surface 500, illustrating a state in which the cartridge 100 has collided with the floor surface 500 from the corner 129b at an angle such that the largest-area surface (Y-Z surface) of the case 120 is inclined by 45 to 90° with respect to the floor surface 500. The advantageous effects of the present disclosure occur also when the cartridge 100 drops and collides in the posture illustrated in FIG. 9. In this case, opposite to the case of FIG. 8, the slit 128a deforms so that the width widens and the slit 128b deforms so that the width narrows, and thereby it is possible to suppress breakage of the element substrate 110.

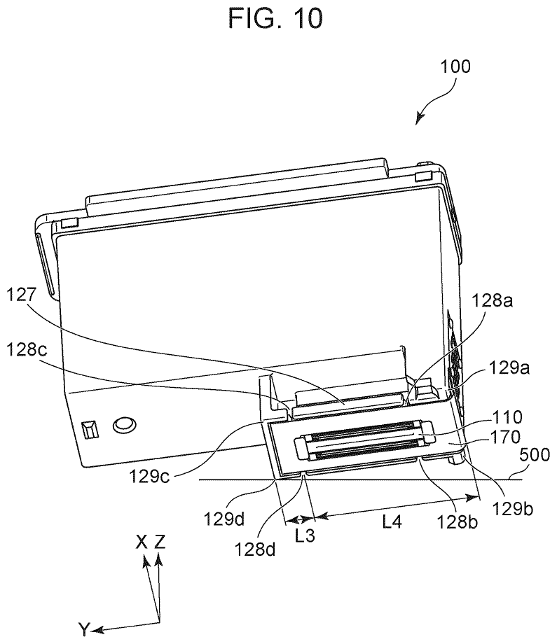

FIG. 10 is another view illustrating a state in which the cartridge 100 has collided with the floor surface 500, illustrating a state in which the cartridge 100 has collided with the floor surface 500 from the corner 129d at an angle such that the largest-area surface (Y-Z surface) of the case 120 is inclined by 45 to 90° with respect to the floor surface 500. The advantageous effects of the present disclosure occur also when the cartridge 100 drops and collides in the posture illustrated in FIG. 10. In this case, the slit 128d deforms so that the width widens and the slit 128c deforms so that the width narrows. At this time, when L3 is a region of the long side 127a from the corner 129d to the slit 128d and LA is a region of the long side 127a from the slit 128d to the corner 129b, since the long side 127a and the entirety of the support surface 127 deform in a V-shape with the slits 128d and 128c as the bending points, bending deformation in the regions L3 and LA is suppressed. Since most of the element substrate 110 is disposed in the region L4, the element substrate 110 does not deform severely, and, as a result, it is possible to suppress breakage of the element substrate 110 even if dropping as illustrated in FIG. 10 occurs.

As described above, for the slit 128 to function as a bending point when the cartridge drops, in a direction parallel to the support surface 127, the slit 128 may be formed so as to extend in a direction that intersects a side (long side) of an outer periphery of the support surface 127 in which the slit is formed at an angle greater than or equal to 45° and less than or equal to 90°.

The cartridge 100 described above has a configuration such that the slits 128 are provided in each of two long sides 127a that form the outer periphery of the support surface 127, and one of the long sides 127a includes at least two of the slits that are disposed with the center of the long side therebetween. However, the present disclosure is not limited to this configuration. With at least one slit, an advantageous effect of cushioning an impact on the element substrate 110 can be obtained.

### <Individual Packaging>

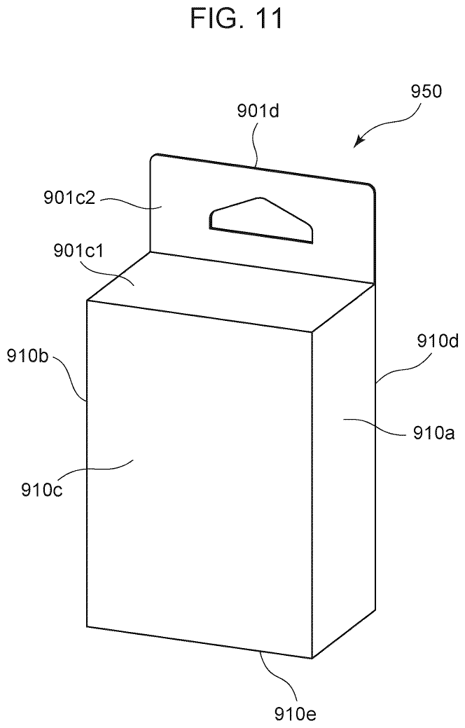

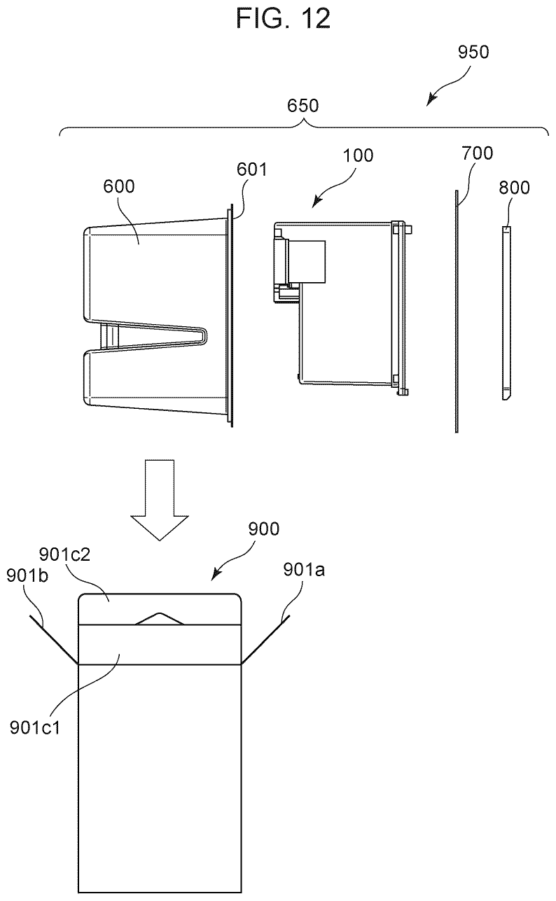

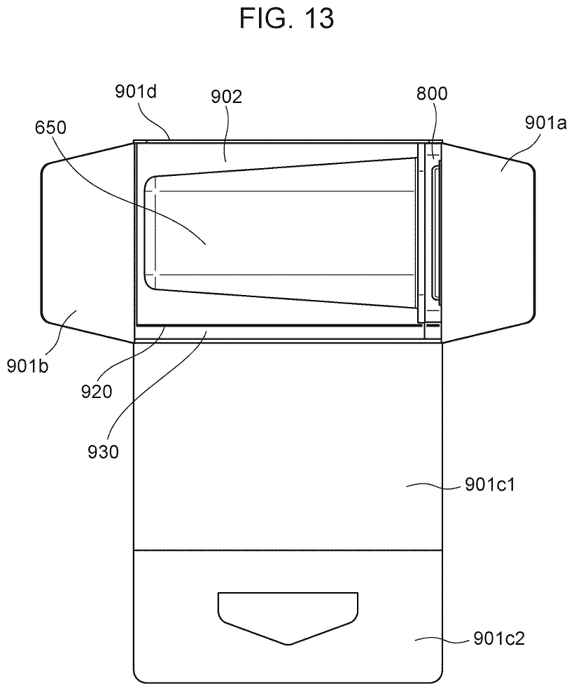

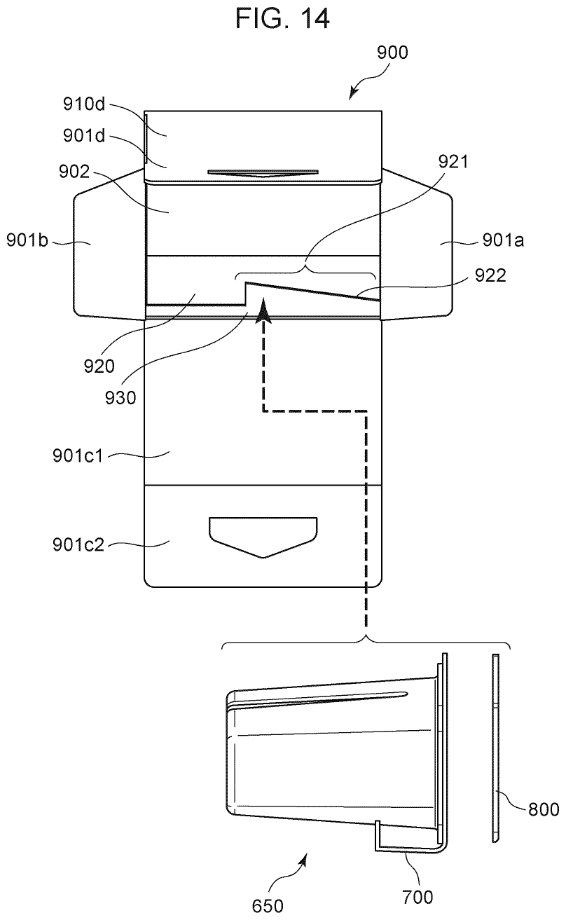

Individual packaging 950, in which the cartridge 100 is contained in an individual packaging box when the cartridge 100 is stored for retail sale in a store or the like, will be described. Also when the individual packaging 950 is dropped in a posture such that the cartridge 100 collides with a floor surface or the like from a portion in the vicinity of the support surface 127, advantageous effects of the present disclosure can be obtained. FIG. 11 is a perspective view of the individual packaging 950 (perspective view of an individual packaging box 900) in a state in which the cartridge 100 is contained in the individual packaging box 900. FIG. 12 is a view illustrating elements included in the individual packaging 950. FIG. 13 is a view viewed from an opening 902 of the individual packaging box 900, and is a view illustrating the individual packaging 950 in a state in which a flap is not folded. FIG. 14 is a perspective view of the individual packaging box 900 viewed from the opening 902 (FIG. 13) side of the individual packaging box 900.

As illustrated in FIG. 12, the individual packaging 950 includes the cartridge 100, a blister container 600, a film 700, a cushioning member 800, and the individual packaging box 900. The cartridge 100 is accommodated in the blister container 600 made of a resin, and further, is hermetically accommodated in the blister container 600 as an opening 601 of the blister container 600 is sealed with the film 700 having flexibility. The cartridge 100 is hermetically accommodated in the blister container 600 in order to suppress evaporation of liquid in the cartridge 100. Thus, failure of smooth ejection of liquid from the element substrate 110, which may occur when the viscosity of the liquid increases due to evaporation of a large amount of the liquid during transportation or during storage, is prevented. In the present embodiment, the film 700 is welded. A resin layer made of the same material as the blister container 600 is provided on a welding surface of the film 700, and hermeticity is maintained as the resin of the blister container 600 and the resin of the film 700 melt and become mixed. A blister pack 650, in which the cartridge 100 is accommodated in the blister container 600 and to which the film 700 is welded, and the cushioning member 800 are accommodated in the individual packaging box 900, and thus the individual packaging 950 is formed. The individual packaging box 900 is made of, for example, paper. After the blister pack 650 and the cushioning member 800 have been accommodated in the individual packaging box 900, the flaps (901a, 901b, 901c1, 901c2, 901d) are folded. First, flaps 901a and 901b are folded inside. Next, flap 901cl is folded so as to close the opening 902 of the individual packaging box. Next, flaps 901c2 and 901d are affixed to each other to close the opening 902 of the individual packaging box 900, and the individual packaging 950 illustrated in FIG. 11 is completed.

Next, a configuration of the individual packaging 950 for cushioning an impact of dropping will be described. The blister container 600 also functions as a protective member for protecting the cartridge 100 from an impact. The blister container 600 is made of a rigid resin. Since an impact of dropping or the like is not directly transmitted to the cartridge 100 but is indirectly transmitted via the blister container 600, the impact is alleviated. Moreover, since the cushioning member 800 made of rigid a resin is disposed on a surface on the blister container opening 601 side to which the flexible film 700 is welded, an impact transmitted to the cartridge 100 is alleviated in the same way.

The individual packaging box 900 also serves to alleviate an impact of dropping. As illustrated in FIG. 13, an inner wall 920 is provided inside of an outer wall 910c that is continuously connected with the flap 901c1. There is a clearance 930 between the outer wall 910c and the inner wall 920, and the distance L5 is 4 mm in the present embodiment. The blister pack 650 and the cushioning member 800 are accommodated in a space surrounded by the inner wall 920, outer walls 910b, 910c, 910d, 910e, and the flap 901c1. Breakage of the element substrate 110 may occur when dropped, particularly in the posture illustrated in FIG. 8, and the inner wall 920 has an impact-cushioning structure specialized for the dropping posture. As described above, there is a clearance between the outer wall 910c and the inner wall 920, and the inner wall 920 is elastically displaceable relative to the outer wall 910c. When the cartridge 100 of the individual packaging 950 drops in the posture illustrated in FIG. 8, the floor surface 500 and the outer wall 910c collide with each other. If dropped from a low elevation, due to the clearance 930, the inner wall 920 does not collide with the outer wall 910c, and the dropping impact is not directly transmitted to the cartridge 100. Even if the dropping height is high and the inner wall 920 collides with the outer wall 910c, the impact is absorbed as the inner wall 920 elastically displaces, and it is possible to minimize the impact transmitted to the cartridge 100. The width of the clearance 930 (the distance between the outer wall 910c and the inner wall 920) may be greater than or equal to 0.5 mm. Moreover, in the present embodiment, a cutout 921 is provided in the inner wall 920. When the cutout 921 is provided, insertion failure, which may occur if the film 700 that has been bent and the inner wall 920 interference with each other while the blister pack 650 is being inserted into the individual packaging box 900, is prevented. If the cutout 921 is not provided, an end portion of the film 700 and an end portion of the inner wall 920 make surface-to-surface contact, and may cause insertion failure. By providing the cutout 921, it is possible to avoid surface-to-surface contact between an inclined surface portion 922 and an end portion of the film 700, and thus insertion failure described above does not occur. Also when the cutout 921 is provided, the impact-cushioning function due to the presence of the inner wall 920 described above can be sufficiently performed. Note that a cartridge according to the present disclosure is not limited to a cartridge contained in the individual packaging box.

### Second Embodiment

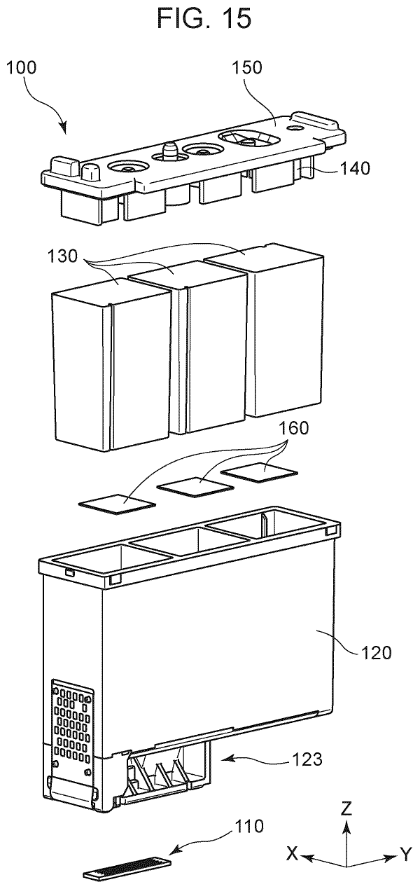

Referring to FIG. 15, a second embodiment will be described. Hereafter, differences from the first embodiment described above will be mainly described, and descriptions of portions similar to those of the configuration described above not being repeated, for conciseness. FIG. 15 is an exploded perspective view of a cartridge 100 according to the second embodiment. The cartridge 100 includes a plurality of liquid storage portions and contains a plurality of types of liquids (inks). In the present embodiment, inks of three colors (cyan, magenta, yellow) are contained. In the present embodiment, a configuration of a color ink cartridge including three storage chambers 121 will be described as an example. However, the number of storage chambers may be two, or four or more. For example, a four-color integrated cartridge for four colors including black in addition to the three colors described above is conceivable.

The element substrate 110 according to the present embodiment includes three ejection port rows 111 respectively corresponding to the three types of inks. Therefore, the size of the element substrate 110 in the X direction is about 5 mm, the size of the element substrate 110 in the Y direction is about 22 mm, and the size of the element substrate 110 in the Z direction is about 1 mm. Since flow paths 122 and ejection ports corresponding to three color inks are formed in the element substrate 110 according to the present embodiment, even though the length (width) in the X direction is about twice that of the first embodiment, the strength is not necessarily increased. For example, regarding an element substrate in which a plurality of flow paths 122 corresponding to three or more color inks are formed or flow paths and ejection ports are provided near an end portion in the width direction, strength against an external stress tends to be low.

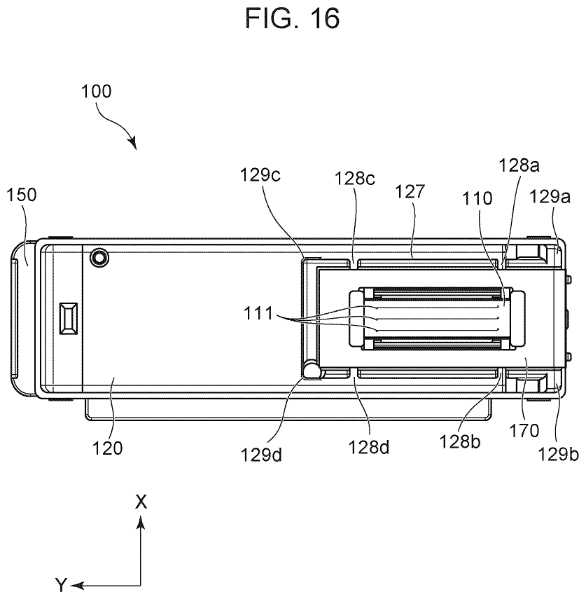

Therefore, the present disclosure is suitably applicable also to the cartridge 100 including the element substrate 110 that can eject a plurality of types of liquids (i.e., a plurality of ink types) as in the present embodiment. FIG. 16 is a view illustrating the cartridge 100 according to the second embodiment viewed from the element substrate 110 side. Slits 128a, 128b, 128c, 128d are provided near respective corners 129a, 129b, 129c, 129d of the support surface 127 having a substantially rectangular shape. The shape of each of the slits 128 is the same as that in the first embodiment. Also with the cartridge 100 according to the second embodiment, even when the cartridge 100 drops and collides with a floor surface or the like in any of the postures illustrated in FIGS. 8 to 10, the cartridge 100 deforms in a direction such that the slit 128 opens or closes, and thereby the element substrate 110 does not deform considerably, and it is possible to suppress breakage of the element substrate 110.

### Additional Embodiments

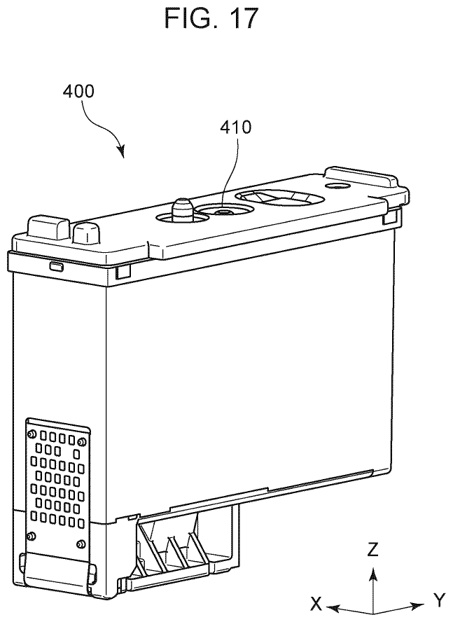

In the embodiments described above, the cartridge 100, which is attachable to and removable from the liquid ejection apparatus, is a disposable-type liquid ejection head that is thrown away when contained liquid is depleted. However, the present disclosure is not limited to a disposable-type cartridge and a liquid ejection apparatus that is used by mounting the cartridge. For example, the present disclosure is suitably applicable to a liquid ejection apparatus that includes a tank having a replenishing port that allows the tank to be replenished with externally supplied liquid and that is configured to supply liquid to the cartridge. A cartridge 400 illustrated in FIG. 17 has a supply port 410 through which liquid is supplied from the tank described above. It is possible to continuously eject ink by a large amount by connecting a tube communicating with the tank to the supply port 410 and continuously supplying liquid.

With the configuration described above, a cartridge with which breakage of an element substrate suppressed is provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-133942, filed Aug. 21, 2023, which is incorporated by reference herein in its entirety.

What is claimed is:

1. A cartridge comprising:
a case including a storage portion for storing liquid and a flow path that communicates with the storage portion;
an element substrate including an ejection port that communicates with the storage portion via the flow path and is configured to eject liquid contained in the storage portion; and
an electric wiring substrate that is electrically connected to the element substrate,
wherein the case has a surface to which the element substrate and the electric wiring substrate are fixed, and
wherein, viewed from a direction perpendicular to the surface, a slit is provided in at least one long side of an outer periphery of the surface.

2. The cartridge according to claim 1, wherein the surface includes a first surface that supports the element substrate and a second surface that supports the electric wiring substrate, and the slit is provided in the second surface.

3. The cartridge according to claim 1, wherein the surface has a plurality of slits.

4. The cartridge according to claim 1, wherein, in a direction parallel to the surface, the slit extends in a direction that intersects the at least one long side in which the slit is formed at an angle greater than or equal to 45° and less than or equal to 90°.

5. The cartridge according to claim 1, wherein the slit is provided at a position separated from a center of the at least one long side.

6. The cartridge according to claim 3, wherein a slit of the plurality of slits is provided in each long side of the outer periphery of the surface.

7. The cartridge according to claim 3, wherein the plurality of slits are disposed with a center of the at least one long side therebetween.

8. The cartridge according to claim 1, wherein, when a stress is applied to the surface, a width of the slit displaces so as to open or close in a direction parallel to the at least one long side.

9. The cartridge according to claim 1,
wherein, viewed from a direction perpendicular to the surface:
the electric wiring substrate has an opening that exposes the element substrate and that has an electrical connection portion with the element substrate, and
at least a part of the slit overlaps the electric wiring substrate.

10. The cartridge according to claim 1,
wherein, when a first direction is a direction in which a plurality of the ejection ports are arranged and a second direction is a direction parallel to the surface and perpendicular to the first direction,
a length of the case in the second direction is less than or equal to 25 mm.

11. The cartridge according to claim 1,
wherein, when a first direction is a direction in which a plurality of the ejection ports are arranged, a second direction is a direction parallel to the surface and perpendicular to the first direction, and a third direction is a direction perpendicular to both of the first direction and the second direction,
a ratio of a length of the cartridge in the third direction to a length of the cartridge in the second direction is greater than or equal to 2.4 and less than or equal to 2.8.

12. The cartridge according to claim 1,
wherein, when a first direction is a direction in which a plurality of the ejection ports are arranged and a second direction is a direction parallel to the surface and perpendicular to the first direction,
a length of the element substrate in the first direction is greater than or equal to 15 mm.

13. The cartridge according to claim 1,
wherein, when a first direction is a direction in which a plurality of the ejection ports are arranged and a second direction is a direction parallel to the surface and perpendicular to the first direction,
a ratio of a length of the element substrate in the second direction to a length of the element substrate in the first direction is greater than or equal to 5.

14. The cartridge according to claim 1,
wherein, viewed from a direction perpendicular to the surface,
a length of the slit in a direction in which the slit extends is greater than or equal to 2.0 mm.

15. The cartridge according to claim 1,
wherein, viewed from a direction perpendicular to the surface,
a width of the slit changes in a direction in which the slit extends.

16. The cartridge according to claim 1, wherein the storage portion is configured to contain ink.

17. The cartridge according to claim 1, wherein the cartridge is attachable to and removable from a liquid ejection apparatus.

18. The cartridge according to claim 1, wherein the surface is substantially rectangular in shape, and
wherein the element substrate further includes an energy generating element for ejecting liquid.

19. A liquid ejection apparatus comprising:
a cartridge including:
a case including a storage portion for storing liquid and a flow path that communicates with the storage portion,
an element substrate including an ejection port that communicates with the storage portion via the flow path and is configured to eject liquid contained in the storage portion, and
an electric wiring substrate that is electrically connected to the element substrate,
wherein the case has a surface to which the element substrate and the electric wiring substrate are fixed, and
wherein, viewed from a direction perpendicular to the surface, a slit is provided in at least one long side of an outer periphery of the surface,
wherein, when a first direction is a direction in which a plurality of the ejection ports are arranged and a second direction is a direction parallel to the surface and perpendicular to the first direction, the cartridge moves in the second direction while causing liquid to be ejected from the element substrate.

20. The liquid ejection apparatus according to claim 19, further comprising a tank that has a replenishing port configured to at least one of (i) allow the tank to be replenished with liquid and (ii) to supply liquid to the cartridge.
